(19) United States
(12) Patent Application Publication
(10) Pub. No.: US 2016/0037967 A1
(43) Pub. Date: Feb. 11, 2016

(54) GRILL WITH ACTIVE PLATE LEVELING CONTROL

(71) Applicant: CARRIER COMMERCIAL REFRIGERATION, INC., Farmington, CT (US)

(72) Inventors: Ronald J. Glavan, Rockton, IL (US); Jeffrey L. Sands, Freeport, IL (US); Dennis J. Nelson, Rockford, IL (US); Otley D. Freymiller, Deerfield, WI (US)

(73) Assignee: Carrier Commerical Refregeration, Inc., Farmington, CT (US)

(21) Appl. No.: 14/773,963

(22) PCT Filed: Mar. 14, 2014
(86) PCT No.: PCT/US2014/028700

§ 371 Date: Sep. 9, 2015

Related U.S. Application Data
(60) Provisional application No. 61/794,835, filed on Mar. 15, 2013.

(51) Int. Cl. A47J 37/06

(52) U.S. Cl. CPC A47J 37/0611

(57) ABSTRACT

A heating apparatus includes a first heating plate (212) configured to contact a first side of an object to heat the object and a second heating plate (222) configured to contact a second side of the object opposite the first side to heat the object. The heating apparatus also includes an actuator assembly (214, 215, 216, 217) configured to move the at least one of the first heating plate and the second heating plate linearly along a first axis and to move the first heating plate rotationally along a second axis perpendicular to the first axis and rotationally along a third axis perpendicular to the first axis and the second axis.

### BACKGROUND OF THE INVENTION

Embodiments of the invention relate to plate leveling control and in particular to a grill or heating apparatus including position control assemblies to control a position of one or more heating plates.

Grills for cooking apply heat from a lower heating plate and from an upper heating plate to opposite sides of a food item to decrease cook times and to cook food evenly. However, differences in a height of food on the lower heating plate may result in the heating plates contacting the food at different times or at different pressures. In addition, if the upper plate is moved toward the lower plate with a hinge, the height of the food on the lower plate may result in the heating plates contacting the food at different times or at different pressures.

### BRIEF DESCRIPTION OF THE INVENTION

Embodiments of the present invention include a heating apparatus including a first heating plate configured to contact a first side of an object to heat the object and a second heating plate configured to contact a second side of the object opposite the first side to heat the object. The heating apparatus also includes an actuator assembly configured to move the at least one of the first heating plate and the second heating plate linearly along a first axis and to move the first heating plate rotationally along a second axis perpendicular to the first axis and rotationally along a third axis perpendicular to the first axis and the second axis.

Embodiments of the invention further include a method of controlling a heating apparatus including a first heating plate configured to contact a first side of an object to heat the first side of an object and a second heating plate configured to contact a second side of the object opposite the first side to heat the second side of the object. The method includes determining an attitude of the first heating plate relative to the second heating plate and controlling a height of at least one of the first heating plate and the second heating plate along a first axis based on determining the attitude of the first heating plate. The method also includes controlling an angle of the first heating plate around a second axis perpendicular to the first axis based on determining the attitude of the first heating plate and controlling an angle of the first heating plate around a third axis perpendicular to the first axis and the second axis based on determining the attitude of the first heating plate.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a heating apparatus according to one embodiment;

FIG. 2A is a diagram of a heating apparatus according to an embodiment;

FIG. 2B is diagram of the heating apparatus according to an embodiment of the invention;

FIG. 3 is a top view of a configuration of actuators according to one embodiment of the invention;

FIG. 4A is a diagram of a heating apparatus according to another embodiment;

FIG. 4B is a diagram of the heating apparatus according to an embodiment of the invention;

FIG. 5 is a diagram of a heating apparatus according to another embodiment;

FIG. 6 is a diagram of a heating apparatus according to another embodiment; and

FIG. 7 is a flowchart of a method according to an embodiment of the invention.

### DETAILED DESCRIPTION OF THE INVENTION

Conventional grilling apparatuses heat food from above and below, but may heat food unevenly due to different food heights, an angle of moving one heating plate towards another and other reasons. Embodiments of the invention relate to controlling the position of heating plates of a grill to supply heat evenly to food. Embodiments also relate to controlling heating plates of any heating mechanism configured to supply heat from opposing sides of an object to heat the object.

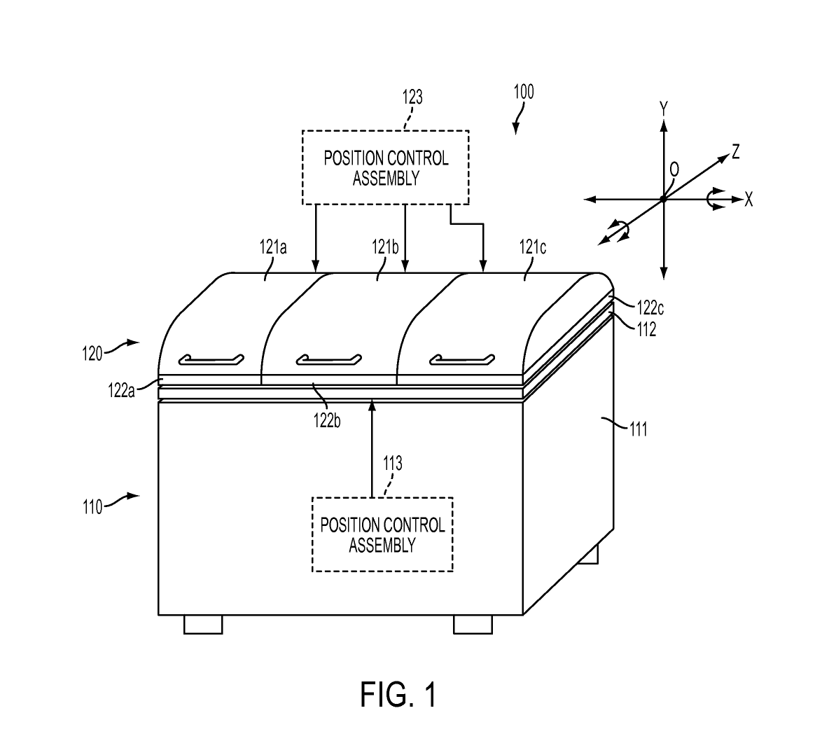

FIG. 1 is a diagram of a heating apparatus 100 according to an embodiment of the invention. In one embodiment, the heating apparatus 100 is a grilling apparatus for grilling food. The heating apparatus 100 includes a lower portion 110 including a base 111 that rests on the ground, floor or another surface. The lower portion also includes a heating plate 112, which may be referred to as a lower heating plate 112. The heating apparatus 100 also includes an upper portion 120 including first, second and third heating units 121a, 121b and 121c that move relative to the base 111. The first heating unit 121a includes a first heating plate 122a, the second heating unit 121b includes a second heating plate 122b and the third heating unit 121c includes a third heating plate 122c. The first, second and third heating plates 122a, 122b and 122c may together be referred to as the upper heating plates 122a, 122b and 122c. In one embodiment, each one of the first, second and third heating units 121a, 121b and 121c is independently movable relative to each other one of the first, second and third heating units 121a, 121b and 121c.

In FIG. 1, one configuration of a heating apparatus 100 is illustrated including a single heating plate 112 on a base 111 and three heating units 121a, 121b and 121c that move with respect to the base 111. However, embodiments of the invention encompass any configuration of base 111, heating units 121 and heating plates 112 and 122, including a number of heating units 121 less than or greater than three, a separate heating plate 112 corresponding to each separate heating unit 121 (such as three separate heating plates 112 to correspond to the three heating plates 122a, 122b and 122c), multiple bases 111 on a same platform, each base 111 corresponding to a separate heating unit 121, or any other desired configuration.

The heating apparatus 100 further includes one or both of a position control assembly 113 to control a position of the heating plate 112 and a position control assembly 123 to control the position of the heating units 121a, 121b and 121c. In embodiments of the invention, the position control assembly 113 or 123 controls the position of the heating plates 112, 122a, 122b or 122c linearly along a height axis Y, rotationally around a length axis X and rotationally around a depth axis Z. The position control assemblies 113 and 123 may be located inside the base 111, inside the heating units 121a, 121b and 121c, or inside both of the base 111 and the heating units 121a, 121b and 121c; or the position control assemblies 113 and 123 may be at least partially external to the base 111 and the heating units 121a, 121b and 121c.

In embodiments of the invention, each of the heating plates 112, 122a, 122b or 122c may be controlled linearly along a height axis Y, rotationally around a length axis X and rotationally around a depth axis Z or only one of the sets of heating plates may be controlled in such a manner. For example, only the upper heating plates 122a, 122b or 122c may be controlled linearly along the height axis Y, rotationally around the length axis X and rotationally around the depth axis Z or only the lower heating plate 112 may be controlled linearly along the height axis Y, rotationally around the length axis X and rotationally around the depth axis Z.

In embodiments of the invention, the position control assemblies 113 and 123 may comprise actuators to move the heating plates 112 and 122, sensors to detect the position and attitude of the heating plates 112 and 122a, 122b and 122c or the heating units 121a, 121b and 121c, and a controller or control circuit to control the movement of the actuators based on the signals received from the sensors. As illustrated in FIG. 1, the height axis Y, depth axis Z and length axis X intersect at an origin O that may be located at any point along a plane defined by the actuators, such as locations where the actuators contact the heating units 121a, 121b and 121c.

In the present specification and claims, the term “attitude” refers to the position of the upper heating plates 122a, 122b, and 122c, the heating units 121a, 121b and 121c, the lower heating plate 112 or the base 111 as determined by the relationship between its axes (i.e. the angle of its length axis, the angle of its depth axis, and its height along a height axis) and a reference datum, such as a floor, the earth or any other surface on which the heating apparatus 100 rests.

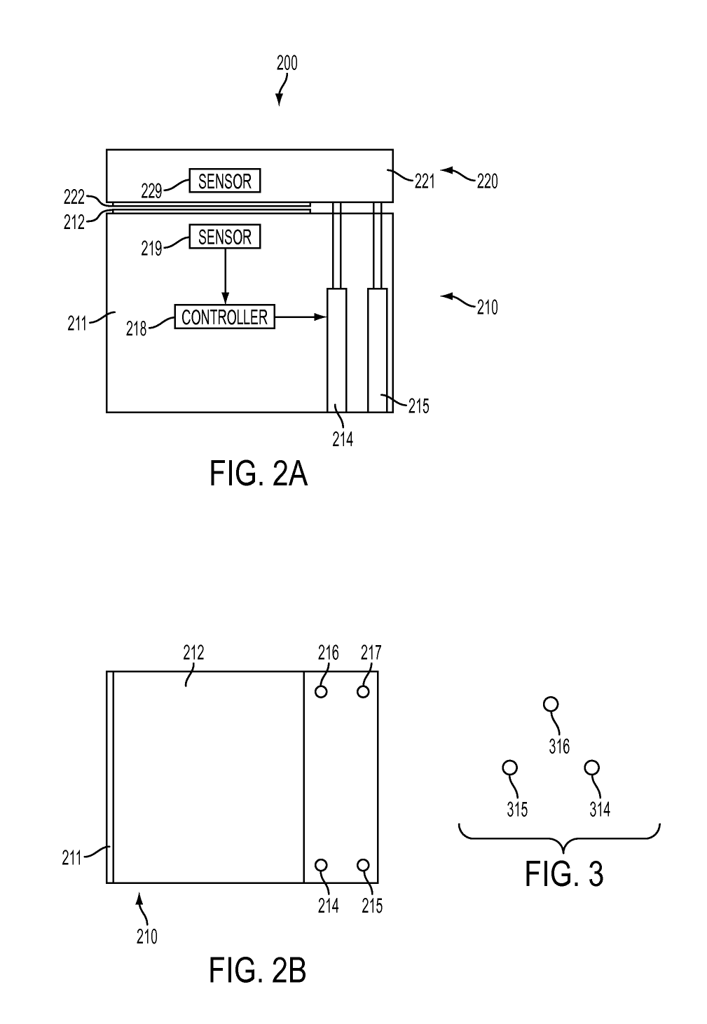

FIGS. 2A and 2B illustrate a heating apparatus 200 according to an embodiment of the invention. The heating apparatus 200 may correspond to the heating apparatus 100 of FIG. 1. The heating apparatus 200 includes a lower portion 210 including a base 211 that rests on the ground, floor or another surface. The lower portion 210 includes a heating plate 212, or a lower heating plate 212. The heating apparatus 200 also includes an upper portion 220 including a heating unit 221 that moves relative to the base 211. The heating unit 221 includes a heating plate 222, or an upper heating plate 222.

In FIGS. 2A and 2B, the position control assembly 113 of FIG. 1 is embodied as sensors 219 and 229, a controller 218 and an actuator assembly including linear actuators 214, 215, 216 and 217 housed in the base 211 and extending from a fixed floor of the base 211 to connect to the heating unit 221. While four linear actuators 214, 215, 216 and 217 are illustrated in FIG. 2B, any number of linear actuators may be used, sufficient to provide stability and a range of movement of the heating unit 221 including the linear movement along a height axis Y, rotational movement around a length axis X and rotational movement around a depth axis Z.

FIG. 3 provides an illustration of a top view of a configuration of linear actuators 314, 315 and 316 that provides the range of movement including the linear movement along a height axis Y, rotational movement around a length axis X and rotational movement around a depth axis Z. In other words, in an embodiment in which only linear actuators are used to control the movement of the heating unit 221, a minimum of three linear actuators 314, 315 and 316 arranged in a triangular pattern may be used to provide the above-described range of movement.

While FIGS. 2A, 2B and 3 are described as controlling linear actuators to provide linear movement along a height axis Y, rotational movement around a length axis X and rotational movement around a depth axis Z, it is understood that the movement of the heating unit 221 or the upper heating plate 222 are not limited to any one axis along a length or depth of the heating unit 221. For example, in the embodiment of FIG. 3 in which movement is provided by three linear actuators, purely linear movement is provided when all three linear actuators move at once with the same velocity. However, when only one or two of the linear actuators moves, or when two or more of the linear actuators move in different directions, the movement may include pure rotation around a single axis or rotation around both a length axis and a depth axis simultaneously.

Referring to FIG. 2B, the rotational axes may be located anywhere along a plane defined by the actuators 214, 215, 216 and 217. For example, if both linear actuators 216 and 217 are moved while the actuators 214 and 215 remain stationary, then the depth axis around which the heating unit 221 rotates corresponds to a line through the ends of the linear actuators 214 and 215. However, if the linear actuators 216 and 217 are moved down while the linear actuators 214 and 215 are moved up, then the depth axis around which the heating unit 221 rotates is located in a center portion of the heating unit 211 between the sets of linear actuators 216/217 and 214/215. In addition, if the linear actuators 215 and 216 remain stationary while the linear actuators 214 and 217 move in opposite directions, the rotation axis corresponds to a line between the ends of the linear actuators 215 and 216. In other words, referring to the directional diagram in FIGS. 1 and 2B, the origin O may be at any point along a plane defined by the ends of the linear actuators 214, 215, 216 and 217.

As illustrated FIGS. 2A and 2B, the actuators 214, 215, 216 and 217 may be located in a non-heat-producing portion of the base 111 and the heating unit 221. In other words, the actuators 214, 215, 216 and 217 extend from the base 111 in a location that does not include the lower heating plate 212 and connects to the heating unit 221 in a location that does not include the upper heating plate 222. Accordingly, damage to the linear actuators 214, 215, 216 and 217 due to heat from being located above the upper heating plate 222 or below the lower heating plate 212 is reduced or eliminated.

In one embodiment, the sensor 229 detects an attitude of the heating unit 221 or the upper heating plate 222 and transmits a signal with data regarding the position of the heating unit 221 or the upper heating plate 222 to the controller 218. In addition, the sensor 219 detects the attitude of the base 211 or the lower heating plate 212 and transmits a corresponding signal to the controller 218. The controller determines the relationship between the attitude of the heating unit 221 or the upper heating plate 222 and the base 211 or the lower heating plate 212 and controls the linear actuators 214, 215, 216 and 217 accordingly. In one embodiment, the controller 218 controls the linear actuators 214, 215, 216 and 217 to cause the upper heating plate 222 to be parallel to the lower heating plate 212. In another embodiment, the controller 218 controls the linear actuators 214, 215, 216 and 217 to cause the upper heating plate 222 to have an attitude corresponding to a height of objects, such as food products, on the lower heating plate 212, to cause the upper heating plate 222 to contact the top surfaces of each of the objects of different heights on the lower heating plate 212.

Embodiments of the invention encompass any type of sensor capable of providing position data to the controller 218. Examples of sensors include inclinometers and accelerometers. In one embodiment, the sensor includes an optical sensor that determines the attitude of the heating unit 221 or the upper plate 222 relative to the base 211 or the lower plate 212 by emitting a beam of light from the base 211, reflecting the beam off of the heating unit 221 and detecting the angle of the received beam at a receiver on the base 211.

While the sensors 219 and 229 are illustrated above and below the upper and lower heating plates 222 and 212, respectively, it is understood that embodiments encompass sensors located at any position in the heating unit 221 and base 211, including in the portion that does not include the upper and lower heating plates 222 and 212 (i.e. corresponding to the location of the linear actuators 214, 215, 216 and 217). In addition, while two sensors are illustrated for purposes of description, embodiments of the invention encompass one sensor in one or the other of the heating unit 221 and the base 211 or three or more sensors.

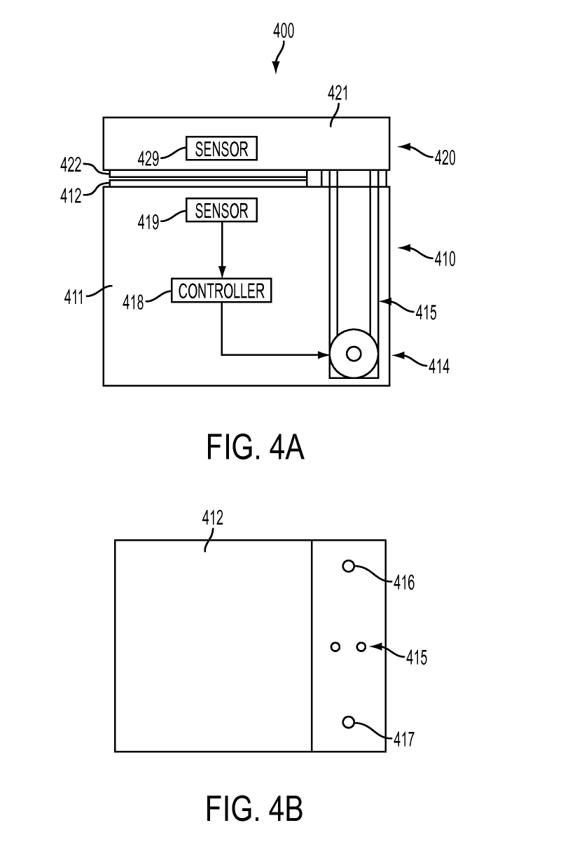

FIGS. 4A and 4B illustrate a heating apparatus 400 according to an embodiment of the invention. The heating apparatus 400 may correspond to the heating apparatus 100 of FIG. 1. The heating apparatus 400 includes a lower portion 410 including a base 411 that rests on the ground, floor or another surface. The lower portion 410 includes a heating plate 412, or a lower heating plate 412. The heating apparatus 400 also includes an upper portion 420 including a heating unit 421 that moves relative to the base 411. The heating unit 421 includes a heating plate 422, or an upper heating plate 422.

In FIGS. 4A and 4B, the position control assembly 113 of FIG. 1 is embodied as sensors 419 and 429, a controller 418 and an actuator assembly including linear actuators 416 and 417 and a motor 414. Connecting lines 415 extend from the motor 414 to the heating unit 421. The connecting lines 415 may be cables, rods or any other connecting lines. In an embodiment in which the connecting lines 415 are cables, the cables are pulled, respectively, to cause a rotation of the heating unit 421 and the upper heating plate 422. In an embodiment in which the connecting lines 415 are rods, the rods may provide both a pushing and a pulling force to rotate the heating unit 421.

In the embodiment illustrated in FIGS. 4A and 4B, the motor 414 controls the rotation of the heating unit 421 around a length axis X and the linear actuators 416 and 417 control the rotation of the heating unit 421 around a depth axis Z. The motor 414 may be movable or the connecting lines 415 may be selectively extendible and the linear actuators 416 and 417 may control a linear movement of the heating unit 421 along a height axis Y.

While FIGS. 4A and 4B illustrate an embodiment in which one motor 414 is used and the motor 414 is located in the base 411, embodiments of the invention encompass any number of motors 414 to control rotation and/or linear movement of the heating unit 421. The motors 414 may be located inside the base 411, outside the base 411, inside the heating unit 421 or outside the heating unit 421, such as above the heating unit 421.

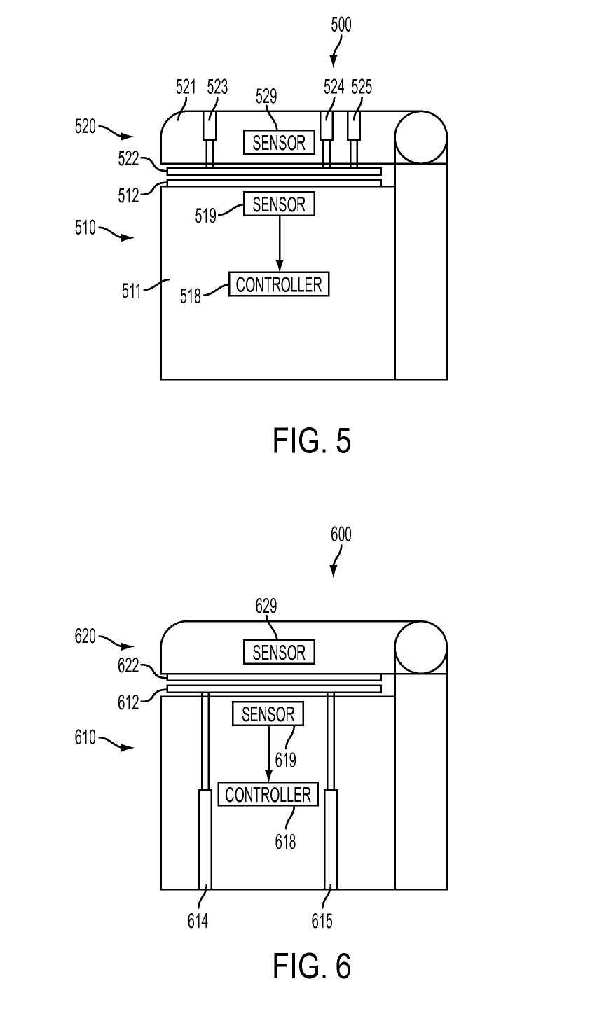

FIG. 5 illustrates a heating apparatus 500 according to an embodiment of the invention. The heating apparatus 500 may correspond to the heating apparatus 100 of FIG. 1. The heating apparatus 500 includes a lower portion 510 including a base 511 that rests on the ground, floor or another surface. The lower portion 510 includes a heating plate 512, or a lower heating plate 512. The heating apparatus 500 also includes an upper portion 520 including a heating unit 521 that moves relative to the base 511. The heating unit 521 includes a heating plate 522, or an upper heating plate 522.

In FIG. 5, the position control assembly 113 of FIG. 1 is embodied as sensors 519 and 529, a controller 518 and an actuator assembly including linear actuators 523, 524 and 525. The linear actuators 523, 524 and 525 may be arranged in triangular arrangement, as illustrated in FIG. 3, or may be part of a larger group of linear actuators, such as four or more linear actuators. The linear actuators 523, 524 and 525 are located in the heating unit 521. When the heating unit 521 is in a closed position, or positioned such that the upper heating plate 522 is located above the lower heating plate 512, the heating unit 521 may be fixed with respect to the base 511. The linear actuators 523, 524 and 525 may be controlled by the controller 518 to move linearly along the height axis Y, to rotate around the length axis X and to rotate around the depth axis Z.

While FIG. 5 illustrates a heating unit 521 that is moved towards and away from the base 511 via a hinge, embodiments of the invention are not limited to this configuration. In other embodiments, the heating unit 521 may be moved towards and away from the base 511 via motors, cables or other actuators extending from a fixed surface above the heating unit 521, such as a shelf, ceiling, housing or any other structure. In addition, while FIG. 5 illustrates the linear actuators 523, 524 and 525 as extending from an upper surface of the heating unit 521 to the upper heating plate 522, embodiments of the invention encompass other configurations in which actuators extend from above the upper heating plate 522 or the heating unit 521 to move the upper heating plate 522 or the heating unit 521. For example, in one embodiment the actuators 523, 524 and 525 extend from fixed surface, such as a shelf, ceiling, housing or other structure down to the upper surface of the heating unit 521 or to a mounting surface within the heating unit 521. In some such embodiments, the hinge illustrated in FIG. 5 may be omitted from the heating apparatus 500.

FIG. 6 illustrates a heating apparatus 600 according to an embodiment of the invention. The heating apparatus 600 may correspond to the heating apparatus 100 of FIG. 1. The heating apparatus 600 includes a lower portion 610 including a base 611 that rests on the ground, floor or another surface. The lower portion 610 includes a heating plate 612, or a lower heating plate 612. The heating apparatus 600 also includes an upper portion 620 including a heating unit 621 that moves relative to the base 611. The heating unit 621 includes a heating plate 622, or an upper heating plate 622.

In FIG. 6, the position control assembly 113 of FIG. 1 is embodied as sensors 619 and 629, a controller 618 and an actuator assembly including linear actuators 614 and 615, which may be two linear actuators among three or more linear actuators in the base 611. The linear actuators 614 and 615 are located in the base 611 and extend from a bottom surface of the base to a downward-facing surface of the heating plate 612. When the heating unit 621 is in a closed position, or positioned such that the upper heating plate 622 is located above the lower heating plate 612, the heating unit 621 may be fixed with respect to the base 611. The linear actuators 614 and 615, as well as one or more actuators (not shown) may be controlled by the controller 618 to move linearly along the height axis Y, to rotate around the length axis X and to rotate around the depth axis Z.

While FIGS. 5 and 6 illustrate linear actuators contacting an upper surface of an upper heating plate 522 and a lower surface of a lower heating plate 612, respectively, it is understood that embodiments of the invention encompass intervening layers or structures such as ceramic or other insulating layers or structures, such that the linear actuators do not directly contact the upper and lower heating plates 522 and 612. In some embodiments of the invention, the sensors 529 and 619 are located within the intervening layers or structures and in other embodiments, the sensors 529 and 619 are external to the intervening layers or structures.

In accordance with embodiments of the invention, actuators may be located in one or both of a base and an upper heating unit of a heating apparatus. In addition, the actuators may actuate one or more of a lower heating plate, an upper heating plate and a heating unit to which the upper heating plate is mounted. In embodiments of the invention, the actuators are controlled to move one or both of the lower heating plate and the upper heating plate in a linear height direction, in a rotational direction around a depth axis and in a rotational direction around a length axis.

In some embodiments, sensors detect an attitude of one or more of the upper heating plate, the heating unit, the lower heating plate and the base, and a controller controls the actuators to align the lower heating plate with the upper heating plate to have a desired relationship with each other, such as to be parallel to each other. In some embodiments, the actuators apply a force from above an upper heating plate or from below a lower heating plate. In other embodiments, the actuators are located on portions of the base and heating unit that do not include heating portions, such as the lower and upper heating plates.

In some embodiments, the actuators apply a force to the heating unit, the upper heating plate or the lower heating plate in addition to a weight applied by the heating unit and the upper heating plate. For example, when linear actuators are located above the upper heating plate, the linear actuators may apply a force against the upper heating plate. Similarly, when linear actuators are located below the lower heating plate, the linear actuators may apply a force to the lower heating plate.

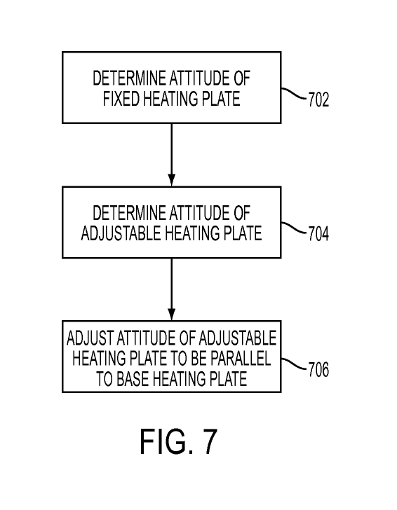

FIG. 7 illustrates a method according to an embodiment of the invention. In block 702, the attitude of a fixed heating plate of a heating apparatus is determined. As discussed previously, the attitude is defined by the relationship between the axes of the fixed heating plate with a reference point, such as the floor or ground. The attitude may be determined based on sensors, such as inclinometers and accelerometers.

In block 704, an attitude of an adjustable heating plate 704 is determined. In one embodiment, an upper heating plate is the fixed heating plate and a lower heating plate is the adjustable heating plate. In another embodiment, the lower heating plate is the fixed heating plate and the upper heating plate is the adjustable heating plate.

In block 706, the attitude of the adjustable heating plate is adjusted to be parallel to the fixed heating plate. The attitude of the adjustable heating plate may be adjusted by controlling three or more actuators to move the adjustable heating plate linearly in a height direction, rotationally around a depth axis and rotationally around a length axis.

While the method has been described with respect to a fixed heating plate and an adjustable heating plate, in some embodiments, both an upper and a lower heating plate is adjustable. In some embodiments, each of the upper and the lower heating plate is adjustable linearly in a height direction, rotationally around a depth axis and rotationally around a length axis. In other embodiments, one or both of the upper and lower heating plates is adjustable in the height direction, but only one of the upper and lower heating plates is adjustable rotationally around the depth axis and rotationally around the length axis.

In addition, while the method has been described to control an adjustable heating plate to be parallel to a fixed heating plate, alternative relationships may be desired, such as aligning the adjustable heating plate at a predetermined angle with respect to the fixed heating plate, according to a size or variety of objects resting on the lower heating plate.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A heating apparatus, comprising:
a first heating plate configured to contact a first side of an object to heat the object;
a second heating plate configured to contact a second side of the object opposite the first side to heat the object; and
an actuator assembly configured to move the at least one of the first heating plate and the second heating plate linearly along a first axis, and to move the first heating plate rotationally along a second axis perpendicular to the first axis and rotationally along a third axis perpendicular to the first axis and the second axis.

2. The heating apparatus of claim 1, wherein the first axis is a height axis corresponding to a height of the heating apparatus, the second axis is a length axis corresponding to a length of the heating apparatus and the third axis is a depth axis corresponding to a depth of the heating apparatus.

3. The heating apparatus of claim 1, wherein the actuator assembly is configured to move the first heating plate based on an attitude of the second heating plate.

4. The heating apparatus of claim 3, further comprising:
at least one sensor configured to determine the attitude of the first heating plate.

5. The heating apparatus of claim 4, further comprising:
a controller configured to receive from the sensor a signal corresponding to the attitude of the first heating plate and to control the actuator assembly based on signal from the sensor.

6. The heating apparatus of claim 5, wherein the controller is configured to control the actuator assembly to maintain the first heating plate parallel to the second heating plate.

7. The heating apparatus of claim 4, wherein the at least one sensor includes a first sensor configured to determine the attitude of the first heating plate and a second sensor configured to determine the attitude of the second heating plate.

8. The heating apparatus of claim 4, wherein the at least one sensor includes at least one of an inclinometer and an accelerometer.

9. The heating apparatus of claim 1, further comprising:
an upper heating unit; and
a base unit beneath the upper heating unit,
wherein the first heating plate is mounted to the upper heating unit.

10. The heating apparatus of claim 9, wherein the upper heating unit includes a lower surface on which the first heating plate is located and an connection portion configured to connect the upper heating unit to the base unit, and
the actuator assembly extends from the base unit to connect to the upper heating unit in the connection portion.

11. The heating apparatus of claim 9, wherein the actuator assembly is connected to an upward-facing surface of the upper heating unit.

12. The heating apparatus of claim 1, further comprising:
an upper heating unit; and
a base unit beneath the upper heating unit,
wherein the first heating plate is part of the base unit.

13. The heating apparatus of claim 12, wherein the actuator assembly is connected to a downward-facing surface of the base unit.

14. The heating apparatus of claim 13, wherein first heating plate is a lower heating plate, and
the actuator assembly is configured to move the first heating plate at least one of axially towards and away from the second heating plate, and rotationally relative to the second heating plate.

15. The heating apparatus of claim 1, wherein the actuator assembly includes at least one of an electrical linear actuator, a motor, a hydraulic actuator, pneumatic actuator and a hexapod actuator.

16. The heating apparatus of claim 1, wherein the actuator assembly includes at least three linear actuators arranged to move the first heating plate linearly along the first axis, rotationally along the second axis perpendicular to the first axis and rotationally along the third axis perpendicular to the first axis and the second axis.

17. The heating apparatus of claim 1, wherein the actuator assembly is configured to apply a force to the object in addition to a force applied by the weight of an upper one of the first heating plate and the second heating plate.

18. The heating apparatus of claim 1, wherein the heating apparatus is a grilling apparatus, the first and second heating plates are grills and the object is a food item.

19. A method of controlling a heating apparatus including a first heating plate configured to contact a first side of an object to heat the first side of an object and a second heating plate configured to contact a second side of the object opposite the first side to heat the second side of the object, the method comprising:
determining an attitude of the first heating plate relative to the second heating plate;
controlling a height of at least one of the first heating plate and the second heating plate along a first axis based on determining the attitude of the first heating plate; and
controlling an angle of the first heating plate around a second axis perpendicular to the first axis based on determining the attitude of the first heating plate; and
controlling an angle of the first heating plate around a third axis perpendicular to the first axis and the second axis based on determining the attitude of the first heating plate.

20. The method of claim 19, wherein determining the attitude of the first heating plate includes receiving a signal from one of an inclinometer and an accelerometer.

21. The method of claim 19, wherein controlling the angle of the first heating plate around the second axis and around the third axis includes controlling two or more linear actuators to rotate the first heating plate.
